(19) United States
(12) Patent Application Publication
(10) Pub. No.: US 2007/0093733 A1
(43) Pub. Date: Apr. 26, 2007

(54) Method and apparatus for treatment of predominant-tone tinnitus

(76) Inventor: Daniel S.J. Choy, New York, NY (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/256,240

(22) Filed: Oct. 21, 2005

(51) Int. Cl. A61H 7/00; A61H 19/00

(52) U.S. Cl. 601/84

(57) ABSTRACT

A portable patient treatment device for treating tinnitus includes a sound producing device, and an audio circuit for producing, through the sound producing device, a treatment sound pattern. The treatment sound pattern has a frequency matched to said patient's tinnitus with phase shifting to reduce the patient's tinnitus. A method for treating tinnitus with a portable patient treatment device includes producing, with said portable device, the treatment sound pattern, where the treatment sound pattern comprises a frequency matched to the patient's tinnitus with phase shifting to reduce the patient's tinnitus. A system for providing a portable patient treatment device for treating a patient's tinnitus includes a base station computer, a portable patient treatment device for producing, through a sound producing device, a treatment sound pattern to reduce the patient's tinnitus; and a connection for selectively connecting the base station computer and the portable patient treatment device for programming said portable patient treatment device.

### CROSS-REFERENCE TO RELATED U.S. APPLICATIONS

This application claims the priority under 35 U.S.C. § 120 of previous U.S. patent application Ser. No. 10/319,281, filed Dec. 12, 2002, which claimed the benefit under 35 U.S.C. § 119(e) of the earlier filing date of U.S. Provisional Application No. 60/340,271, filed Dec. 18, 2001. Both of these previous applications are hereby incorporated by reference in their respective entireties.

### BACKGROUND

Tinnitus is defined as the perception of sound by an individual when no external sound is present, and often takes the form of a hissing, ringing, roaring, chirping or clicking sound which may be intermittent or constant. According to the American Tinnitus Association, tinnitus afflicts more than 50 million Americans, and more than 12 million of those suffer so severely from tinnitus that they seek medical attention and many cannot function normally on a day-to-day basis.

Tinnitus, often referred to as ringing in the ears, is estimated to be present in approximately 50% of the US population over 65 years of age. In general, tinnitus takes many and varied forms, which may be related to its underlying cause. Tinnitus may be caused by, or related to, such diverse factors as trauma, drugs, hearing loss, the normal aging process or other unknown causes.

Previous approaches to treating tinnitus have focused on masking the tinnitus noise experienced by patients. While previous masking techniques have been unable to alleviate the problems of tinnitus patients, significant research has been done. In reporting on studies at the Oregon Tinnitus Clinic, Jack Vernon, director of the Oregon Hearing Research Center, stated that, in patient tinnitus studies, phase and tone relationships are of obvious and critical importance in tone masking of tinnitus. Vernon goes on to observe that one cannot repress the idea of canceling tinnitus by a proper phase adjustment of the external tone used in masking.

In commenting on Wegel's earlier tinnitus treatment findings that a slight mistuning of a masking external tone produced a beat-like sensation with the tinnitus sound, Vernon reported that, in a 100 patient study, he was able to detect a slight beat-like sensation in only four instances. Vernon therefore concluded that the beat-like sensation found by Wegel was most probably due to octave confusion resulting from Wegel not using a single pure tone, but rather a narrow band of noise. In conclusion, Vernon observed that phase manipulation justifies further patient studies as a masking parameter for tonal tinnitus treatments. Vernon's report on possible phase manipulation for treating tinnitus patients remained unchanged from its original publication in 1991 and as included in the 1997 edition of Shulman's treatise entitled “Tinnitus Diagnosis and Treatment.”

Neither current medical procedures nor electronic or sonic instrumentation permit or facilitate an objective determination an instantaneous phase of a point on a patient's virtual predominant tinnitus tone. This current state of tinnitus treatment has been bothersome for the tinnitus patient because the current state of medical knowledge and acoustic/electronics instrumentation does not yet permit one to objectively determine at what point on a patient's virtual endogenous tinnitus sound wave tinnitus tone (sine wave) an exogenous phase-shifted sine wave should be inserted in an attempt to cancel the patient's virtual tinnitus noise.

### SUMMARY

A portable patient treatment device for treating tinnitus includes a sound producing device, and an audio circuit for producing, through the sound producing device, a treatment sound pattern. The treatment sound pattern has a frequency and amplitude matched to said patient's tinnitus with phase shifting to reduce the patient's tinnitus. A method for treating tinnitus with a portable patient treatment device includes producing, with said portable device, the treatment sound pattern, where the treatment sound pattern comprises a frequency matched to the patient's tinnitus with phase shifting to reduce the patient's tinnitus. A system for providing a portable patient treatment device for treating a patient's tinnitus includes a base station computer, a portable patient treatment device for producing, through a sound producing device, a treatment sound pattern to reduce the patient's tinnitus; and a connection for selectively connecting the base station computer and the portable patient treatment device for programming said portable patient treatment device.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram of predominant-tone tinnitus treatment apparatus in accordance with an embodiment of the present invention.

FIGS. 2A, 2B, 2C, 2D and 2E are a series of sine waves that graphically illustrate phase shift cancellation principles in accordance with embodiments of the present invention.

FIGS. 3A, 3B and 3C graphically illustrate the summation and cancellation for an assumed patient tinnitus wave form and an externally generated wave form having an arbitrary assumed offset of θ degrees in accordance with embodiments of the present invention.

FIG. 4 illustrates a portable patient treatment device and supporting system according to principles described herein.

FIG. 5 illustrates the principal internal components of the portable patient treatment device of FIG. 4.

FIG. 6 illustrates a portable patient treatment device and supporting system according to principles described herein.

FIG. 7 is a flowchart illustrating an exemplary method of operating the portable patient treatment device according to principles described herein.

FIG. 8 is a flowchart illustrating an exemplary method of operating a base station for the portable patient treatment device according to principles described herein.

Throughout the drawings, identical reference numbers designate similar, but not necessarily identical, elements.

### DETAILED DESCRIPTION

To remedy the current deficiencies in diagnosing and treating tinnitus patients, and more particularly predominant-tone tinnitus, applicant has developed a new, more efficient phase cancellation treatment process and apparatus that overcomes many of the shortcomings in the prior art. There is a long-felt need for an effective treatment for predominant-tone tinnitus patients to substantially reduce, relieve or eliminate the often substantially debilitating condition of tonal tinnitus.

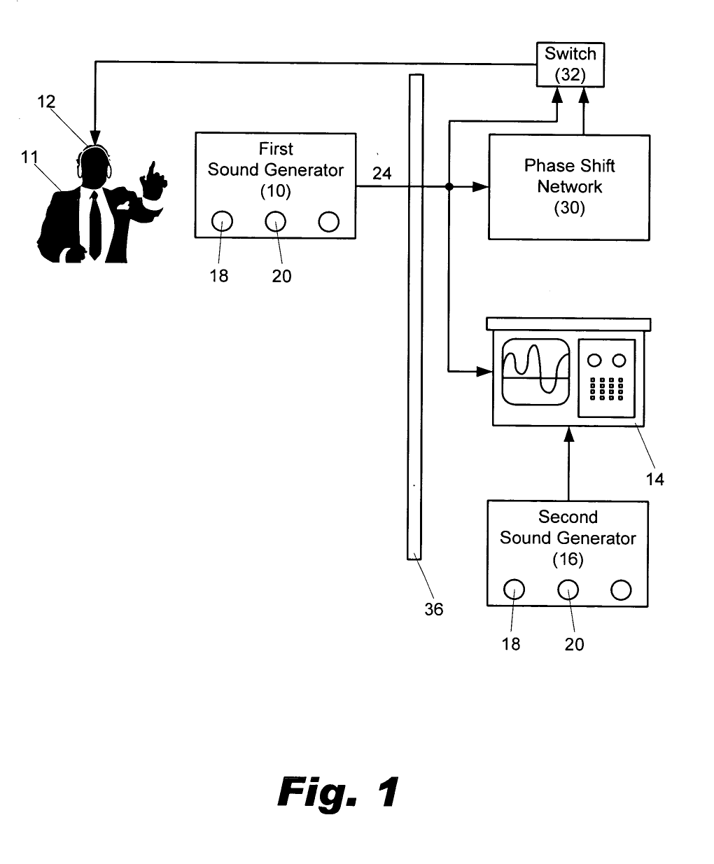

Referring now to FIG. 1, a preferred embodiment of a phase shift treatment system for predominant-tone tinnitus patients is illustrated in block diagram form. A sound generator (10), for example, an Agilent model 33120A function generator or any equivalent commercially available wave form generator, is coupled to a patient's headset (12) and to an input of an oscilloscope (14) which may, for example, be of the type commercially available in the U.S. from Tektronics, Inc. A second sound generator (16) is also coupled to another input of the oscilloscope (14).

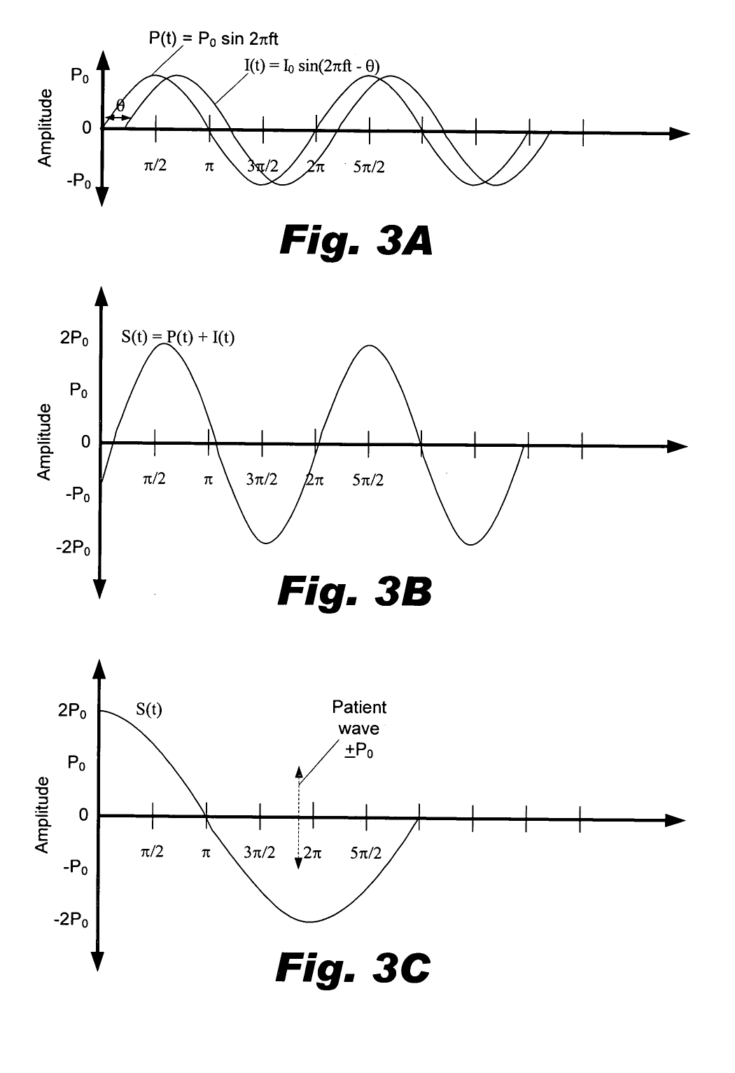

Sound generator (10) has a plurality of adjustable knobs (18 and 20) and an output terminal (24). As will be hereinafter explained in further detail, particularly with respect to FIG. 3, a predominant-tone tinnitus patient (11) is asked to adjust the frequency and amplitude of an audio signal generated by the sound generator (10) using, respectively, the knobs (18 and 20) until the output of the sound generator applied to a sound producing device, such as speakers or headphones (12), matches the tinnitus predominant tone heard by the patient (11). For ease or reference, headphones will be discussed herein, while those of skill in the art will appreciate that any sound producing device may be used.

This subjective “sound-typing” is preferably repeated a plurality of times on a blind basis, i.e. the patient cannot see the oscilloscope (14). A barrier (36) may be placed between the patient (11) and the oscilloscope (14) and the sound generator (10). Alternatively, either there is no display on the sound generator (10) that a patient (11) can observe, or any such display is masked and concealed from the patient (11). In this manner, if the patient (11) is able to subjectively select roughly the same parameters a number of times to match his or her perceived tinnitus noise with the sound generator (10), there can be confidence that the output of the sound generator (10) accurately approximates the tinnitus noise experienced by the patient (11).

The subjective sound typing data for each of the self-typing steps is preferably recorded by an attending audiologist or physician. Additionally, the output of the first sound generator (10) can be matched by adjusting a second sound generator (16) to produce the same output. The outputs of the first sound generator (10) and the second sound generator (16) can be compared on the oscilloscope (14) to ensure that they are the same. The output of the second sound generator (16) can be used, as will be described below, to prepare a treatment device for the patient (11).

The principles of sound wave cancellation operate by superimposing, e.g. summing, a second sine wave having the same frequency and amplitude, as the first sine wave with a phase shift of 180 degrees. Sound wave cancellation is well understood in the electrical and measurement arts and is utilized in many technical fields including audiology, mechanics and electronics generally. With predominant-tone tinnitus, the patient should be able to adjust the output of the first sound generator (10) to approximate the tinnitus noise that he or she hears.

The method of accomplishing the phase shift cancellation effect of summing two waves of the same frequency and amplitude, but without any knowledge of the phase relationship of the first wave to the second wave relative to a common point, can be illustrated as follows. Sound generator (10) is set to a first tone having a frequency of f₁ and an amplitude of A (for example in milli-volts as displayed on sound generator (10)) and connected to the first input of multi-beam oscilloscope (14). A second generator (16) is also set to the same tone with a like amplitude and the output is connected as a second input to oscilloscope (14).

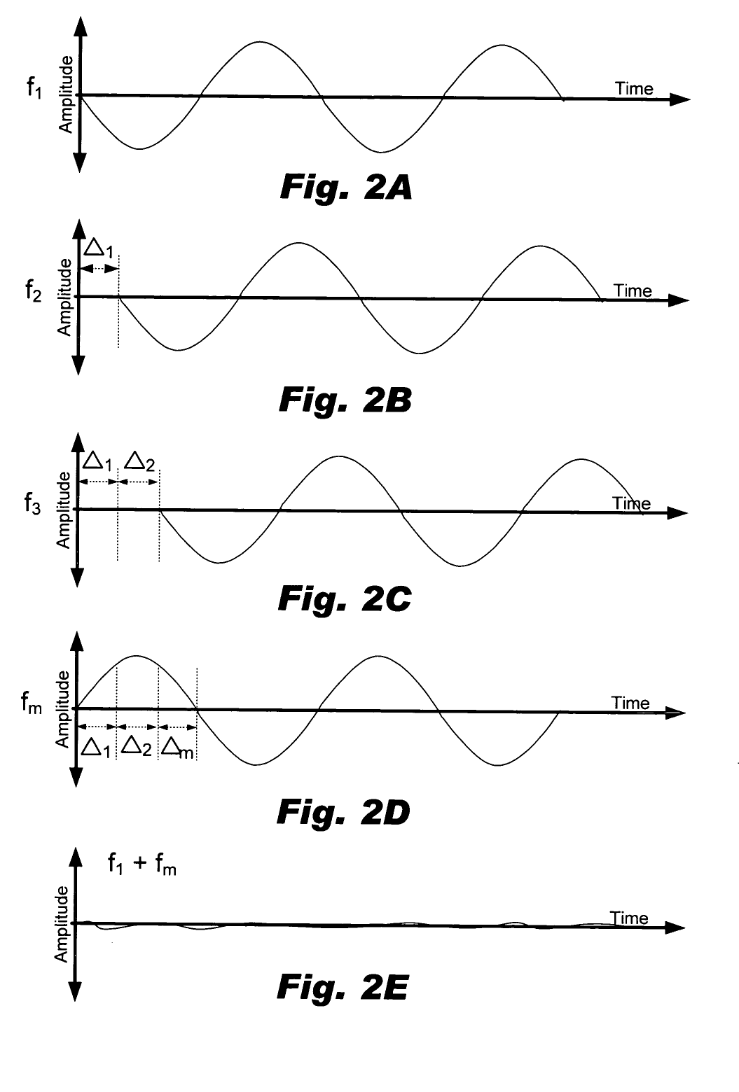

With reference to FIGS. 2A-2E, it may be seen that by adjusting the phase of sine wave f through a series of steps, illustrated as f₁ . . . fₘ, the sum of f₁ plus fₘ (FIG. 2E) neutralizes or cancels the original signal f₁. As illustrated, f₁, plus fₘ cancel when fₘ is 180 degrees out of phase with f₁. While the simple addition of two tonal sounds wave may be useful for illustrative purposes, the structure and operation of the human auditory system is much more complex.

It is well understood in the field of audiology that humans and animals can determine, to a considerable degree of precision, the direction of a sound wave remote from them and to some extent can also estimate the distance of a sound source. Numerous experiments in the field of audiology have attempted to analyze the mechanics by which so-called binaural localization is accomplished in humans and animals. There are two primary factors which assist one in determining the direction of an arriving sound: (1) relative intensity in the hearer's two ears and (2) the difference in phase between the ears or, for a sinusoidal tone, the difference in phase between the sound waves arriving at the right and left ear of the hearer respectively. Thus, it is clear that a human or animal auditory system can distinguish phase shifts of complex sound generally and for pure tones or predominant tones specifically. This type of auditory analysis is frequency dependent and, for frequencies above 1 Khz, most observers tend to determine the direction of a sound source from the side of the ear receiving the louder sound. Thus in general, it appears that auditory localization by phase difference is most definite for a band of frequencies in the order of a few kilohertz. As discussed hereinafter, with reference to FIG. 3, in implementing tinnitus treatments, it is important to determine not only the tonal quality of the tinnitus signal but whether the tinnitus patient hears his/her tinnitus in both ears, in only one ear or, as many indicate when asked where they hear the tinnitus, in their head without reference to either ear. Referring again to FIG. 1, the structure and operation of applicant's preferred embodiment of apparatus for treating predominant-tone tinnitus patients will be further described. A phase shift network (30) may be of any type known to those skilled in the auditory and electrical arts for applying a desired phase shift to the output of the first sound generator (10). Alternatively, the sound generator (10) may incorporate an output wave form phase shift feature. To select the wave form phase shift feature, an operator may dial in the desired phase shift (scaled in degrees), e.g. 10 degrees, 20 degrees etc. which affects the desired shifts, e.g. of Δ₁, Δ₂, etc. as shown in FIG. 2 or an appropriate automatic switching arrangement may be used.

As shown in FIG. 1, a switch (32) can selectively send the output of the first sound generator (10) to the patient's headphones (12). In an alternate position, the switch (32) sends the output of the phase shift network, i.e., the signal from the first sound generator (10) plus a phase shift, to the patient's headphones (12). If the sound generator (10) does not have a phase shift feature, the separate phase shift network (30) is utilized. The headphones (12) are preferably a high quality headset commercially available from, for example, Bose, Inc. of Massachusetts, U.S.A., under the trademark QuietComfort.

Switch (32), as illustrated, applies the shifted output of the sound generator (10) to the headphones (12). The successively phase-shifted increments of sine wave tone from generator (10), as explained above, are successively generated relative to f₁, as illustrated in FIG. 2, to accomplish the reciprocal 180 degree phase canceling relationship through the steps illustrated as f₂, f₃,. . . fₘ.

Referring now to FIG. 3A, there is shown a theoretical graphical representation of the summing of a patient's tinnitus tone P(t) and an externally generated tone I(t) along with their respective mathematical equation representations. As stated above, the patient's tinnitus tone P(t) cannot be measured with existing electronic or sonic instrumentation, but, for convenience of discussion and analysis, it is illustrated as a sine wave of a particular frequency f(t). The respective wave forms for a patient's tinnitus tone P(t) and the generated wave form I(t) are based, as explained above, on the patient self-typing of his/her tinnitus tone as compared to the output of a sound generator (10), as explained in connection with FIG. 1.

FIG. 3B illustrates a single sine wave representing the sum S(t) of P(t) and I(t) with the initial offset or separation angle θ as shown in FIG. 3A. The sum is expressed by its mathematical equivalent S(t). FIG. 3C illustrates the amplitude of a sine wave representing the arithmetic sum of the patient tinnitus wave P(t) and the input generated wave I(t). As illustrated in FIG. 3C the arithmetic sum S(t) of the two offset wave forms P(t) and I(t) having the aforementioned angular offset θ has an instantaneous amplitude less than the patient's tinnitus tone sound wave due to the cancellation effected by the offset phase shift angle θ which results in a diminution or cancellation of the patient's tinnitus tone as illustrated between the 2π/3 to the 4π/3 degree points on the sum S(t) wave form. Thus for approximately one-third of the 360 degree scale illustrated, partial cancellation occurs. By incrementally shifting the external tinnitus treatment tone I(t), we can theoretically nullify or completely cancel the patient's tinnitus tone P(t) when the input treatment tone I(t) reaches the 180 degree out-of-phase position, as shown in

FIG. 2, as it slides across the patient tinnitus tone P(t) as described above. For a more complete understanding of the diminution and cancellation of a theoretical patient's tinnitus tone, reference may be had to FIGS. 3A, 3B and 3C and the following mathematical definitions and equations relating thereto:
Patient Sine Wave:
   P(t) =P₀ sin 2πft
   Where P₀ is amplitude, f is frequency and t is time.
Input Sine Wave from Generator:
   I(t)=I₀ sin (2πft−θ)
   Where θ is the phase shift between P(t) and I(t) in radians. π radians=180°, 2π=360°.
Sum of P(t) and I(t):
S(t)=P(t)+I(t)=(P₀ sin 2πft)+I₀ sin (2πft −θ)
Assume that P₀=I₀, then

$$\begin{matrix}S ( t ) = {P}_{0} [ sin 2 π t + sin ( 2 π f t - θ ) ] \\ = [ 2 {P}_{0} cos ( 1 / 2 θ ) ] \cdot [ sin ( 2 π f t - 1 / 2 θ ) ] \\ = A sin ( 2 π f t - 1 / 2 θ )\end{matrix}$$

where A is the amplitude of the sum wave.
Thus,
A=2P₀ cos (½θ);
sin (2πft−½θ) is the sinusoidal variation of the sum wave; and
½θ is the phase shift of the sum wave.

Once a treatment sound pattern for a patient has been determined, that sound pattern can be applied to the patient's ears. As noted above, application of the treatment sound pattern for a limited time, for example a half hour to an hour, can result in a decrease or elimination of the patient's tinnitus for an extended period that may range from days to weeks. However, it is usually necessary to repeat the treatment periodically by having the patient listen to the treatment sound pattern to restore or reinforce the relief from the tinnitus symptoms.

Because it is obviously inconvenient for the patient to return to the treating physician or clinician's office each time the treatment is to be repeated, the present specification described a novel portable patient treatment device (PTD) that can be used by the patient on a prescribed or as needed basis for continuing relief from tinnitus symptoms.

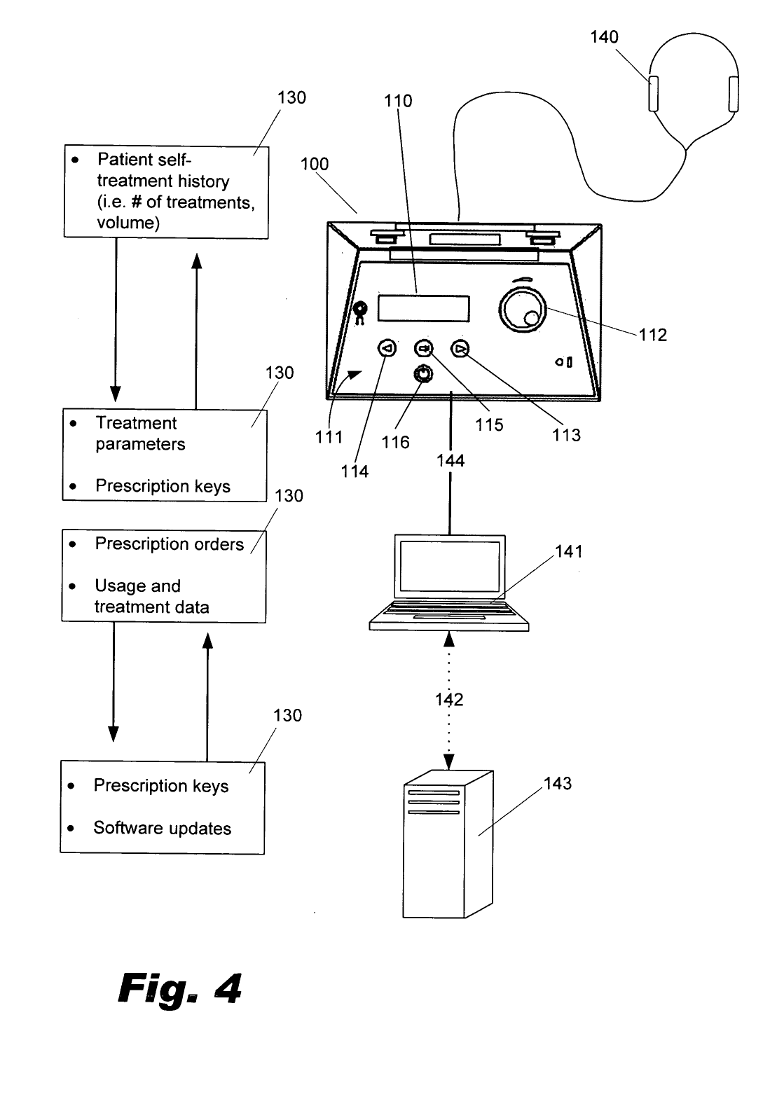

FIG. 4 illustrates one example of the PTD and supporting system according to principles described herein. As shown in FIG. 4, the PTD (100) is a portable unit with headphones or a headset (140) that can be worn by the patient. Because the PTD is portable, the patient can keep the PTD (100) at home or at hand for use in treating his or her tinnitus on a prescribed or as-needed basis. For example, the PTD (100) may be sized to provide portability while promoting use in an environment conducive to effective therapy.

The headset (140) may be a pair of headphones, ear-bud headphones or any other means of delivering an audio treatment program to the ears of the patient. However, high quality, closed earphones have the advantage of minimizing ambient noise. The headphones (140) may be integrated with the PTD or may be plugged into a jack on the PTD.

In some examples, the PTD (100) contains a recording of the treatment sound pattern prescribed for the patient. This recording may be, for example, in digital form, such as a WAV file, MP3 file or the like. In other examples, the PTD (100) includes an audio signal generator and programming for the generator that will result in an audio signal to the headset (140) that represents the treatment sound pattern prescribed for the patient.

The PTD (100) may also include a control knob (112). The control knob (112) may be used to control any number of settings, with which a patient can adjust the volume or other characteristics of the treatment sound pattern. A display (110) may be provided on the PTD (100) to advise the patient of information, such as, the amount of battery life remaining in the PTD (100), the volume level, the amount of time remaining in an ongoing treatment session and the amount of time the current treatment is authorized for further use, as will be described in more detail below. The display (110) may be, for example, a liquid crystal display (LCD). The PTD (100) may also have other user controls (111) that allow the patient to initiate or discontinue a treatment session or other wise control the PTD (100). The user controls (111) may include any device for receiving user input including, but not limited to, buttons, switches, touch sensitive display, dials, knobs, sliders, rocker switches, etc. For example, according to the present exemplary embodiment, the user controls (111) include an advance button (113), a back button (114), a mute button (115), and a power button (116).

Initially, the PTD (100) is connected (144) to a base station (141) for programming by the physician or clinician treating the patient. The base station (141) may be, for example, a computer or laptop. The connection (144) may be, for example, a Universal Serial Bus (USB) connection. The PTD (100) is connected (144) to the base station (141) and is programmed with the treatment sound pattern for the patient. This programming may include downloading a recording of the treatment sound pattern to the PTD (100) or providing programming to the PTD (100) that will allow an audio signal generator in the PTD (100) to produce a signal corresponding to the treatment sound pattern.

Additionally, the base station (141) may communicate with a central server (143). The communication between the base station (141) and the central server (143) may take place, for example, over an Internet connection (142). The central server (143) tracks the treatment of the patient and authorizes successive treatment periods with the PTD (100).

As shown in FIG. 4, the data flow within the system is as follows. When treatment is to be initiated, the central server (143) downloads a treatment license and/or any software updates (133) to the base station (141). The treatment license is a string or code that authorizes and enables the base station (141) and PTD (100) to provide treatment for a set period of time to the patient. Treatment licenses are provided by the central server (143) in response to treatment orders (132) from the base station (141). The base station (141) may also send usage and treatment data (132) to the central server (143) for archiving and analysis.

The base station (141), in turn, provides the treatment license (131) and the treatment parameters (recording or programming) (131) to the PTD (100). With the treatment license and treatment parameters (131), the PTD (100) can be used by the patient to provide the desired treatment over a defined period of time. The PTD (100) may be programmed not to function or provide treatment if a valid treatment license is not loaded by the base station (141) or if the prescribed treatment period has expired.

Lastly, when the PTD (100) is again connected to the base station (141), the PTD (100) may download a record of the treatment self-administered by the patient using the PTD (100). This may include, for example, the number of times treatment was administered, i.e., the PTD (100) was used, the times or frequency of the treatments, the volume setting used during each treatment, changes to the volume setting during treatment, etc.

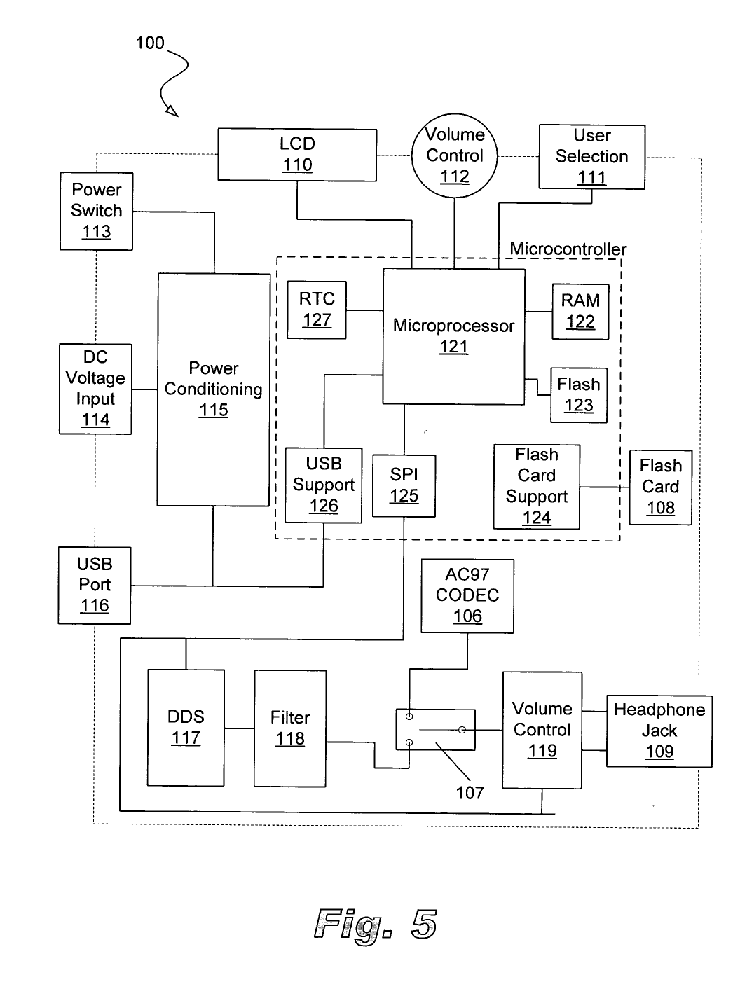

FIG. 5 illustrates the principal internal components of the portable patient treatment device of FIG. 4. As shown in FIG. 5, the PTD (100) includes the display (110), volume control (112) and user input device (111) described above. These components are connected to a microcontroller (120) which controls the operation of the PTD (100).

The microcontroller (120) includes, for example, a microprocessor (121) which executes programming or firmware stored in memory, for example, Flash memory (123). The Flash memory (123) may be internal or a removable Flash memory card (108) that connected to a Flash card support (124) of the microcontroller (120). The programming or firmware is loaded into Random Access Memory (RAM) (122) for execution by the microprocessor (121).

The microcontroller (120) also includes a clock (127), known as a Real Time Clock (RTC). This clock (127) tracks the passage of time so that the PTD (100) can determine when an authorized treatment period has ended. As described above, the PTD (100) will then stop functioning until provided with a new treatment period authorization, for example, a new treatment license.

In some examples, the RTC (127) may also include a counter that counts the number of times a prescription sound treatment pattern has been played. A limit may be placed on the number of times the prescription treatment is played as a backup to the expiration of the treatment period for requiring receipt of a new prescription and a new treatment license.

In some examples, the microcontroller (120) also includes an interface (125) that connects the microcontroller to a Direct Digital Synthesizer (DDS) (117). The DDS (117) is the audio signal generator that produces the treatment sound pattern if a recording of the treatment sound pattern is not being used. The frequency and phase of the DDS (117) will be set by the microprocessor (121) though the interface (125) as required to meet the therapy parameters. The output of the DDS (117) will be filtered by a filter (118) and amplified through a programmable volume control (119). The output of the volume control amplifier (119) is then fed into the headphone jack (109). In such an example, the volume control amplifier (119) may be controlled through the interface (125).

If, instead, an electronic recording of the treatment sound pattern is being used, the recording file can be stored in the Flash memory (123) or Flash Card memory (108). The recording file is then read through the microcontroller (120) and played through a Coder-Decoder (Codec) (106). The codec (106) is connected to the volume control amplifier (119) and the headphone jack (109).

As described above, some PTDs may operate using a recorded sound treatment pattern. Other PTDs may operate using only the DDS with appropriate programming. The PTD (100) shown in FIG. 5 includes both such possibilities. A switch (107) is then provided for selectively connecting either the DDS (117) and filter (118) or the codec (106) to the volume control amplifier (119) and the headphone jack (109). The switch (107) can be controlled with the user input device (111) so that the user can decide which system to use, or may be controlled by the microprocessor (120) with the physician or clinician deciding which system will be used.

The PTD (100) also has a power system including a power button or switch (113) for turning the PTD (100) on and off. Power is provided for the PTD (100) by one of three sources. First is a rechargeable battery. Second is a DC voltage from a medical grade wall mounted AC-DC converter connected to a DC voltage input (114). The third is a USB port (116).

Under normal operation the system will be powered by the AC-DC converter through the DC voltage input (114) and a power conditioning unit (115). The power conditioning unit (115) may include the rechargeable battery and charger. When DC voltage is applied, the battery is recharged. The system will then be able to operate as a stand-alone device using the rechargeable battery.

A USB port (116) is also provided for connecting the PTD (100) to the base station as described above. The USB port (116) communicates with the microcontroller (120) though a USB support unit (126) as shown in FIG. 5. The USB port (116) may also be a source of power as described above.

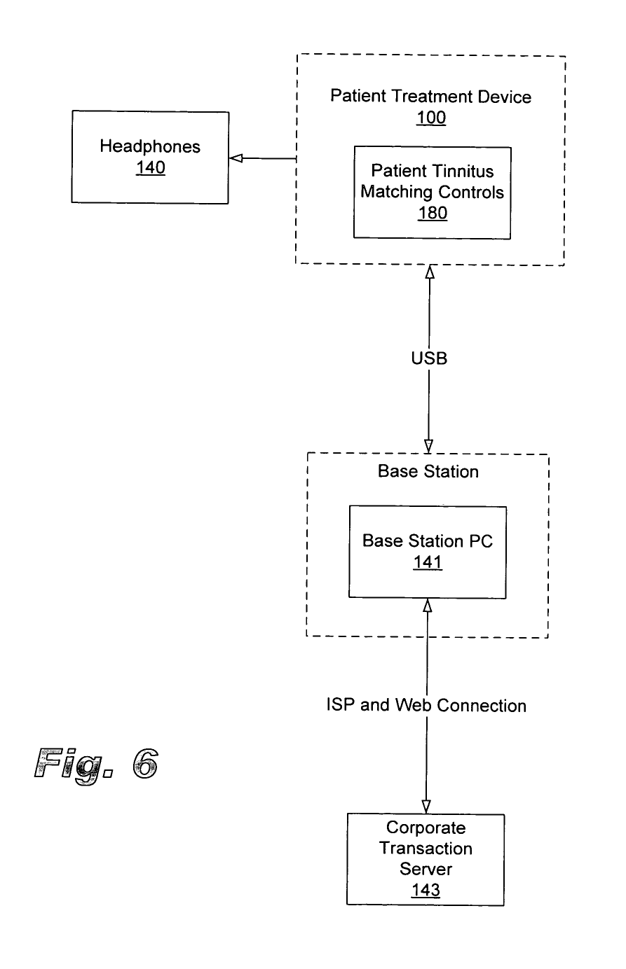

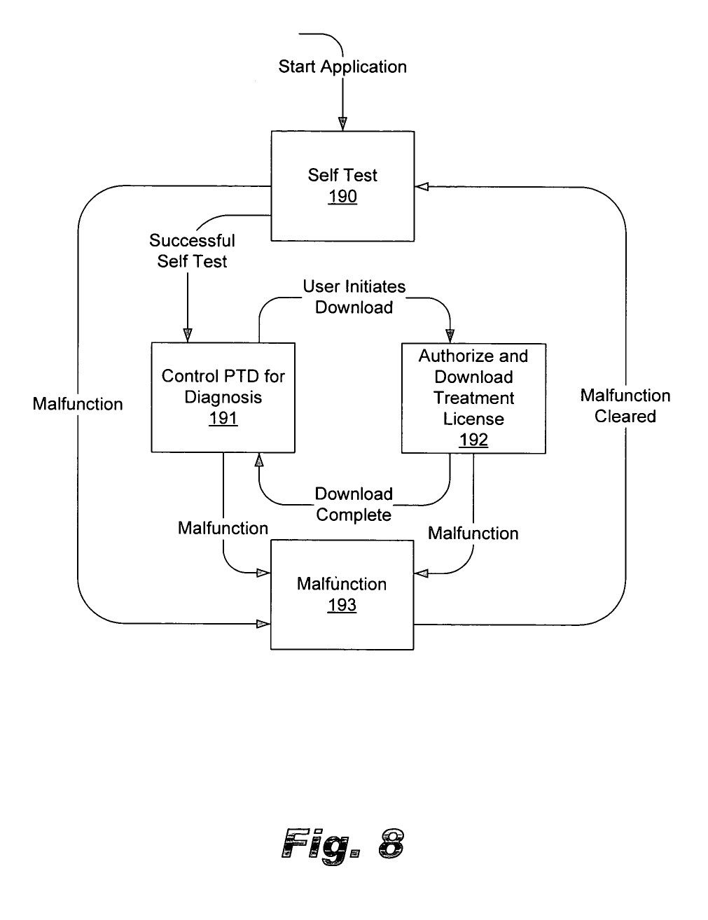

FIG. 6 illustrates a portable patient treatment device and supporting system according to principles described herein. As shown in FIG. 8, the PTD (100) delivers the treatment sound pattern to the headset or headphones (140). The headset (140) can be integrated with the PTD (100) or plugged into a jack in the PTD (100) as described above.

The PTD (100) is connected with the base station computer (141) during programming of the PTD (100). The PTD (100) is connected to the base station computer (141) through a USB connection, as described above. The knob (112), described above, or other control devices, constitute the patient tinnitus matching controls (180) which may be part of the PTD (100). Alternatively, the patient tinnitus matching controls (180) may be separately coupled to the PTD (100). The base station computer (141) communicates with a central server (143) via an internet or Web connection as described above.

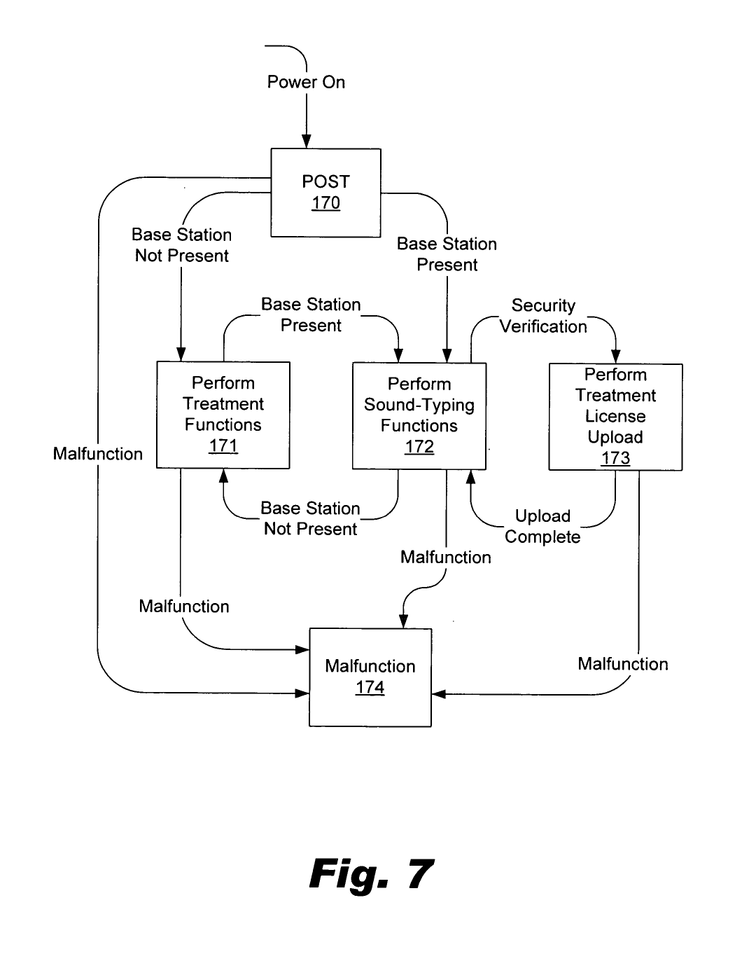

FIG. 7 is a flowchart illustrating an exemplary method of operating the portable patient treatment device according to principles described herein. After turning on power to the unit, the PTD will perform a Power On Self Test (POST) (170). This test will verify that the hardware is working properly and that any external communications are valid. A failure of POST will cause the system to transition to a malfunction state (174).

Upon completion of POST (170), if the Base Station is not connected, the unit will perform the stand-alone treatment functions (171) described above, for example, providing the prescribed sound treatment pattern under the control of the user. The stand-alone treatment functions (171) may also include displaying a user interface on which a user can select options or receive information; adjusting the volume; creating a log of the treatment received by the patient including time stamp, volume and treatment duration; monitoring for connection with the base station; and verifying the expiration date of the current prescription. The system compares the prescription expiration date to the Real-Time Clock and allows treatment to be administered only prior to expiration.

If the base station is present following successful completion of the POST, the sound-typing functions (172) are performed as described above to determine the sound treatment pattern suited for the patient. The sound-typing functions (172) may also include creating a data log of the frequencies tried for a match with the patient's tinnitus and monitoring to make sure that the connection with the base station remains. If the connection is broken, the PTD transitions to performing treatment functions (171).

If the base station is present or connected to the PTD, upon a verified security communication, the unit can upload a treatment license (173) from the central server. A prescription includes a frequency and expiration date. The frequency matches the tinnitus frequency subjectively identified by the patient as described above. The PTD then automatically phase shifts the frequency as described above to effectively cancel the patient's perception of the tinnitus tone.

During the download of a new prescription, the Real- Time Clock can be changed or updated. At other times, the system may refuse to allow adjustment the Real-Time Clock to avoid misuse of the system with an expired prescription.

FIG. 8 is a flowchart illustrating an exemplary method of operating the base station according to principles described herein. FIG. 8 also represents a tinnitus treatment application that runs on the base station computer described above. As shown in FIG. 8, once the tinnitus application is started on the base station computer, a self test is performed (190). This test will verify that the patient tinnitus matching controls (180, FIG. 6) and the PTD (100, FIG. 6) are properly connected to the base station (141, FIG. 6) and are functioning. A failure of the self test will cause the application to transition to a malfunction state.

Upon successful completion of the self test (190), the base station will control the PTD and use the input from the matching controls for diagnosis (191) of the patient's tinnitus and creation of the needed treatment sound pattern. Prior to diagnosis, patients should undergo an evaluation by an ear, nose and throat physician to ensure that they are appropriate candidates for the tinnitus treatment described herein. Conditions that are medically or surgically treatable should be ruled out. Patients should also have a hearing test performed to identify hearing loss, which is often related to the onset of tinnitus.

The initial treatment session is focused on evaluating the characteristics of a patient's tinnitus and designing a treatment sound wave that will ameliorate the patient's tinnitus as described above. The patient will be asked to listen to a customized sound pattern for thirty minutes after sound-typing has been completed. Subsequently, the patient returns for additional in-office treatments to ensure that the desired effect is being achieved. The number of additional visits may vary, depending upon the patient and/or clinician.

The tinnitus application running on the base station computer may include, for the diagnosis phase (191), a user interface that allows the user to start and stop sound typing and prompts the user for patient data, a harmonic check that allows the user to generate tones that are harmonics of the selected tones to confirm the soundtyping; a data log that allows the user to download treatment data from the PTD and append that data to a patient record, a patient record manager that allows the user to read and updated patient records (changes to a patient record may required security verification), a reset control for the PTD; communication with the matching controls to read the frequency and volume settings input with the matching controls; and a control for the PTD to send frequency, phase and volume settings to the PTD.

When the diagnosis is completed, the user can issue a command for the base station to authorize and download a treatment license (192). As indicated above, the prescription is authorized and issued by, for example, the central server (143, FIG. 4). This may involve entering security verification data, communicating with the central server to confirm authorization to issue the prescription, downloading the authorized prescription to the PTD and updating or synchronizing the Real-Time Clock of the PTD.

Patients may be required to attend follow-up visits with clinicians in order to renew their customized, duration specific treatment licenses and to ensure that the treatment plan continues to provide effective relief. If the characteristics of the patient's tinnitus have changed, any of the sound characteristics may be changed. For example, the sound pattern may be adjusted as necessary. Treatment license renewals through follow-up up visits will also aid in the diagnosis of any pathological diseases. Additionally, these visits will allow the physician to continue collecting clinical data on the long-term effectiveness of the treatment program. In addition to renewal through office visits, those of skill in the art will appreciate that treatment licenses may be renewed in other ways. For example, the treatment license may also be renewed remotely, such as over the Internet.

The preceding description has been presented only to illustrate and describe embodiments of invention. It is not intended to be exhaustive or to limit the invention to any precise form disclosed. Many modifications and variations are possible in light of the above teaching.

What is claimed is:

1. A portable patient treatment device for treating tinnitus, said device comprising:
a sound producing device; and
an audio circuit for producing, through said sound producing device, a treatment sound pattern,
wherein said treatment sound pattern comprises a frequency matched to said patient's tinnitus with phase shifting to reduce the patient's tinnitus.

2. The device of claim 1, wherein said sound producing device comprises a headset.

3. The device of claim 1, wherein said audio circuit comprises a memory for storing a recording of said treatment sound pattern.

4. The device of claim 1, wherein said audio circuit comprises a Direct Digital Synthesizer for producing said treatment sound pattern.

5. The device of claim 1, further comprising a display device for displaying data for said patient.

6. The device of claim 1, further comprising a processor programmed to provide said treatment sound pattern only if said device has received a current treatment license.

7. The device of claim 6, further comprising a clock for timing expiration of said treatment license, wherein said processor will stop providing said treatment sound pattern upon expiration of said current treatment license until a new treatment license is loaded to said device.

8. The device of claim 1, further comprising a log system for tracking data about said patient's use of said treatment sound pattern.

9. The device of claim 1, further comprising a volume control.

10. The device of claim 1, further comprising a rechargeable battery.

11. A system for providing a portable patient treatment device for treating a patient's tinnitus, said system comprising:
a base station computer;
a portable patient treatment device comprising an audio circuit for producing, through a sound producing device, a treatment sound pattern comprising a frequency matched to said patient's tinnitus with phase shifting to reduce the patient's tinnitus; and
a connection for selectively connecting said base station computer and said portable patient treatment device for programming said portable patient treatment device.

12. The system of claim 11, wherein said connection is a Universal Serial Bus (USB) connection.

13. The system of claim 11, wherein said audio circuit comprises a memory for storing a recording of said treatment sound pattern.

14. The system of claim 11, wherein said audio circuit comprises a Direct Digital Synthesizer for producing said treatment sound pattern.

15. The system of claim 11, wherein said portable device further comprises a processor programmed to provide said treatment sound pattern only if said device has received a current treatment license.

16. The system of claim 15, wherein said portable device further comprises a clock for timing expiration of said treatment license, wherein said processor will stop providing said treatment sound pattern upon expiration of said current treatment license until a new treatment license is loaded to said device.

17. The system of claim 16, further comprising a connection between said base station computer and a central server, wherein said base station requests authorization to issue treatment licenses to said portable patient treatment device from said central server.

18. The system of claim 17, wherein said connection between said base station computer and a central server comprises an Internet connection.

19. The system of claim 11, further comprising a log system for tracking data about said patient's use of said treatment sound pattern, wherein said portable patient treatment device downloads said tracked data about said patient's use of said treatment sound pattern to said base station computer over said connection.

20. The system of claim 19, wherein said base station computer download said tracked data to a central server that authorizes continuing use of said portable patient treatment device.

21. The system of claim 11, further comprising tinnitus matching controls connected to said base station for matching said patient's tinnitus to produce said treatment sound pattern.

22. A method for treating tinnitus with a portable patient treatment device, said method comprising producing, with said portable device, a treatment sound pattern,
wherein said treatment sound pattern comprises a frequency matched to said patient's tinnitus with phase shifting to reduce the patient's tinnitus.

23. The method of claim 22, wherein producing said treatment sound pattern is performed with a memory of said portable device for storing a recording of said treatment sound pattern.

24. The method of claim 22, wherein producing said treatment sound pattern is performed with a Direct Digital Synthesizer.

25. The method of claim 22, wherein said treatment sound pattern is produced only if said device has received a current treatment license.

26. The method of claim 25, further comprising timing expiration of said treatment license, wherein said device will stop providing said treatment sound pattern upon expiration of said current treatment license until a new treatment license is loaded to said device.

27. The method of claim 22, further comprising tracking data about said patient's use of said treatment sound pattern.

28. A method for treating a patient's tinnitus with a portable patient treatment device, said method comprising selectively connecting a base station computer and said portable patient treatment device for programming said portable patient treatment device to produce a treatment sound pattern comprising a frequency matched to said patient's tinnitus with phase shifting to reduce the patient's tinnitus.

29. The method of claim 28, further comprising providing said treatment sound pattern only if said portable device has received a current treatment license.

30. The method of claim 29, further comprising timing expiration of said treatment license, wherein said portable device will stop providing said treatment sound pattern upon expiration of said current treatment license until a new treatment license is loaded to said device.

31. The method of claim 30, further comprising requesting, with said base station computer, authorization to issue treatment licenses to said portable patient treatment device from a central server.

32. The method of claim 31, wherein said connection between said base station computer and a central server comprises an Internet connection.

33. The method of claim 31, further comprising renewing said treatment license.

34. The method of claim 33, wherein renewing said treatment license includes visiting a doctor's office.

35. The method of claim 31, wherein renewing said treatment license includes accessing a central server.

36. The method of claim 28, further comprising:
tracking data about said patient's use of said treatment sound pattern; and
downloading said tracked data about said patient's use of said treatment sound pattern to said base station computer.

37. The method of claim 36, further comprising downloading said tracked data to a central server that authorizes continuing use of said portable patient treatment device.

38. The method of claim 28, further comprising sound-typing said patient tinnitus with said base station computer connected with said portable patient treatment device.

39. A portable patient treatment device for treating tinnitus, said device comprising:
means for producing sound; and
means for producing, through said means for producing sound, a treatment sound pattern,
wherein said treatment sound pattern comprises a frequency matched to said patient's tinnitus with phase shifting to reduce the patient's tinnitus.
